(19) United States
(12) Patent Application Publication
(10) Pub. No.: US 2011/0056050 A1
(43) Pub. Date: Mar. 10, 2011

(54) ROPE LOK

(75) Inventor: Douglas Hassing, Kalamazoo, MI (US)

(73) Assignee: Rope Lok, LLC, Otsego, MI (US)

(21) Appl. No.: 12/734,035

(22) PCT Filed: Oct. 3, 2008
(86) PCT No.: PCT/US08/11478

§ 371 Date: Nov. 8, 2010

Related U.S. Application Data
(60) Provisional application No. 60/997,815, filed on Oct. 5, 2007.

(51) Int. Cl. F16G 11/04

(52) U.S. Cl. 24/132 R

(57) ABSTRACT

The present invention relates to a locking device for holding a length of linear flexible material under tension wherein the locking device comprises a lever locking element further comprising a locking means. More specifically, the invention relates to a locking device wherein one or more lengths of linear flexible material may be permanently attached to a main body element and at least one length of linear flexible material may be inserted through one or more grooves or tubes in the main body element allowing the lever locking element to engage the length of linear flexible material such that the length of linear flexible material may be placed under tension.

### FIELD OF THE INVENTION

The present invention relates to a locking device for holding a length of linear flexible material under tension wherein the locking device comprises a lever locking element further comprising a locking means. More specifically, the invention relates to a locking device wherein one or more lengths of linear flexible material may be permanently attached to a main body element and at least one length of linear flexible material may be inserted through one or more grooves or tubes in the main body element allowing the lever locking element to engage the length of linear flexible material such that the length of linear flexible material may be placed under tension.

### BACKGROUND OF THE INVENTION

It is well known that various ratchet devices, cam locks, fasteners and jam cleats have been devised to hold or place a length of linear flexible material under tension. In some instances it is necessary to knot a rope or similar length of linear flexible material in order to secure it. In other instances, the linear flexible material may be a wire held under tension with fasteners. Many jam cleats and cam locks are designed such that the device is fixed to a surface to allow the tie down of an item at a particular location. Ratchet devices may be movable; however, ratchet devices are typically elaborate multiple component devices. Fasteners have the disadvantage of being fixed in place.

The present invention provides for a simple locking device which allows a length or lengths of linear flexible material to be engaged under tension. Advantages include simplicity of construction, operation, speed and ease of operation, and safety. Such a locking device is not necessarily permanently attached to a surface allowing the locking device to be movable such that the locking device may be used to secure a plethora of items.

### SUMMARY OF THE INVENTION

The primary objective of the present invention is to provide a locking device that is easy to use and strong. By so doing, the locking device may be engaged quickly and with little effort and yet maintain tension in a length of linear flexible material.

What I therefore believe to comprise my invention may be summarized inter alia in the following words:

A locking device comprising a main body element further comprising one or more grooves or tubes though which one or more lengths of linear flexible material may pass, one or more lever locking elements each further comprising a handle and a locking means, which lever locking element is pivotally attached to the main body element such that the lever locking element may engage a length of a linear flexible material passing through the one or more grooves or tubes, and such that engagement of the locking means creates a region of the linear flexible material on either side of the engagement of the locking means of either higher or lower tension;

Such a locking device, wherein the one or more grooves or tubes traverse the main body element and such that the one or more lengths of linear flexible material exit the main body element in both high and low tension, depending on the respective end of the main body element in relation to the lever locking element;

Such a locking device, wherein the one or more grooves or tubes are proportionate to the diameter of the one or more lengths of linear flexible material;

Such a locking device, wherein the main body element further comprises a means for permanently attaching the length of linear flexible material at either one or both the high tension end or low tension end of the main body element;

Such a locking device, wherein one end of a single length of linear flexible material may be permanently attached to the main body element and the other end of the single length of linear flexible material may be inserted into the groove or tube of the main body element such that it may be engaged by the locking means;

Such a locking device, wherein the lever locking element is positioned such that the locking means is positioned at the high tension end of the main body element and the handle rotatable toward the low tension end of the main body element;

Such a locking device, wherein the lever locking element is pivotally attached at the high tension end of the main body element;

Such a locking device, wherein the locking means is in the form of a cam or curved wedge which may engage the length of linear flexible material directly against an interior wall of the groove or tube of the main body element when the length of linear flexible material is inserted into the locking device such that tension applied to the high tension end of the length of linear flexible material operates to reinforce the engagement of the cam or curved wedge;

Such a locking device, wherein the locking means engages the length of linear flexible material when the handle is rotated toward the main body element, thereby engaging the length of linear flexible material with the cam or curved wedge, and releases the length of linear flexible material when the handle is rotated away from the main body element, thereby disengaging the cam or curved wedge;

Such a locking device, wherein the handle surface is smooth or textured;

Such a locking device, wherein more than one lever locking elements is pivotally attached to the main body element in series on the same surface of the main body element such that the length of linear flexible material may be engaged by more than one locking means while positioned in the groove or tube of the main body element;

Such a locking device, wherein more than one lever locking element is pivotally attached to the main body element in parallel on the same surface of the main body element such that more than one length of linear flexible material may pass through the more than one groove or tube on the same surface of the main body element, and such that more than one locking means may engage the lengths of linear flexible material in the same direction;

Such a locking device, wherein more than one lever locking element is pivotally attached to the main body element in bidirectional parallel on the same surface of the main body element such that more than one length of linear flexible material may pass through more than one groove or tube on the same surface of the main body element, and such that more than one locking means may engage the lengths of linear flexible material in opposite directions;

Such a locking device, wherein more than one lever locking element is pivotally attached on opposite surfaces of the main body element such that more than one length of linear flexible material may pass through more than one groove or tube on the opposite surfaces of the main body element, and such that more than one locking means may engage the lengths of linear flexible materials in the same direction;

Such a locking device, wherein more than one lever locking element is pivotally attached on opposite surfaces of the main body element such that more than one length of linear flexible material may pass through more than one groove or tube on the opposite surfaces of the main body element, and such that more than one locking means may engage the lengths of linear flexible material in opposite direction;

Such a locking device, wherein the length of linear flexible material is a rope;

Such a locking device, wherein the groove(s) or tube(s) comprise a conductive material on the inner surface of such groove(s) or tube(s) and connecting such groove(s) or tube(s) such that when the locking means is engaged an electric current may be conducted through and between the respective lengths of linear flexible material which are engaged against the groove(s) or tube(s)

The locking device of Claim 16, wherein the length of linear flexible material is a conductive material such as a wire; and

Such a locking device, further comprising a conductive clip proportionate to the locking device comprising two mirror image linear components, wherein each linear component comprises an extension on either end of the linear component, which extensions extend at 90 degrees from the linear component, and the extensions further comprise an opening to receive an opposite end of the linear component of a complimentary conductive clip such that the two linear components interlock, and the linear components further comprise a conductive material such that when the two linear components are interlocked encircling the locking device, a charge may pass between the conductive material in each conductive clip and an electric current may be conducted through the wires and between the wires.

### BRIEF DESCRIPTION OF THE DRAWINGS

FIG. 1 is a schematic side elevation view of the present invention;

FIG. 2 is a schematic view of the side of the present invention;

FIG. 3 is a schematic view of the front of the main body element of the present invention;

FIG. 4 is a schematic side elevation view of the main body element of the present invention;

FIG. 5 is a schematic view of the side of the main body element of the present invention;

FIG. 6 is a schematic side elevation view of the lever locking element of the present invention;

FIG. 7 is a schematic view of the side of the lever locking element of the present invention;

FIG. 8 is a close up view of the handle of the lever locking element wherein the handle surface is textured; and

FIG. 9 is a close up view of the locking means of the lever locking element comprising a cam or curved wedge.

FIG. 10 is a schematic view of an embodiment of the present invention illustrating a lever locking element on both sides of the main body element.

FIG. 11 is a schematic view of the side of the conductive clip of the present invention.

FIG. 12 is a schematic view of the conductive clip encircling the locking device of the present invention.

### DETAILED DESCRIPTION OF THE INVENTION

The present invention relates to a locking device which comprises a main body element further comprising one or more grooves or tubes through which one or more lengths of linear flexible material may pass, one or more lever locking elements further comprising a handle and a locking means, which lever locking element is pivotally attached to the main body element such that the one or more locking means may engage under tension the one or more lengths of linear flexible material passing through the one or more grooves or tubes. The main body element may, optionally, be attached to a length of linear flexible material which may be permanently attached at one end of the locking device. The one or more locking means may be in the form of a cam or a curved wedge.

Operationally, the act of engaging the length of linear flexible material by use of the locking means functions to define an end of the main body element wherein the length of linear flexible material is under high tension and an end of the main body element wherein that same length of linear flexible material is under low tension. Moreover, the positioning of the locking means is such that the tension imposed on the length of linear flexible material operates to promote the engagement of the locking means by drawing the cam or curved wedge tighter to the main body element and thereby further securing the length of linear flexible material.

The locking device may be formed using techniques typical in the art from a variety of durable materials including, but not limited to, metal, aluminum, plastic, or other durable material. An embodiment may be an injection molded durable plastic.

The length of linear flexible material includes, but is not limited to, ropes, cords, wires, conductive material or similar material made from materials typical in the art. Furthermore, in an embodiment the thickness or diameter of the length of linear flexible material may vary depending on the type of item one is attempting to secure. An embodiment is a solid braid or solid core rope which is ⅜″ in diameter. In another embodiment, the length of linear flexible material may vary depending on the type of item one is attempting to secure. In another embodiment, the length of linear flexible material is a wire or other conductive material used for fencing or other similar type of barrier.

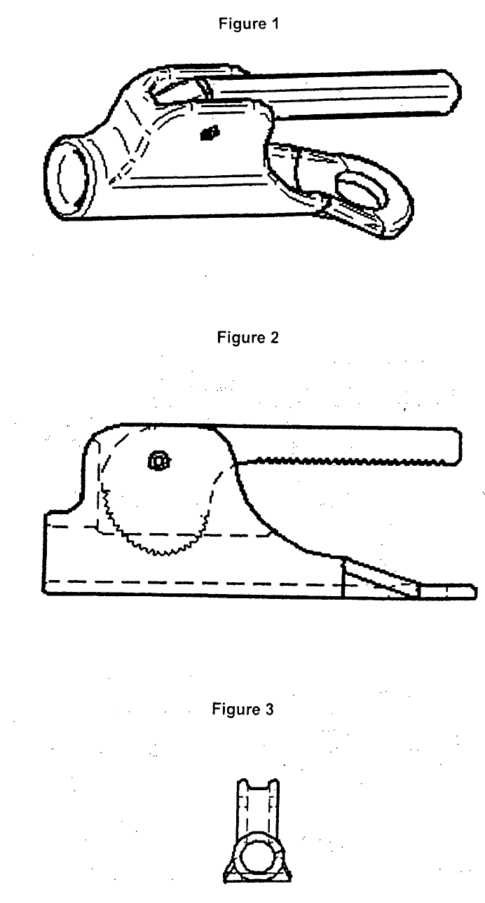

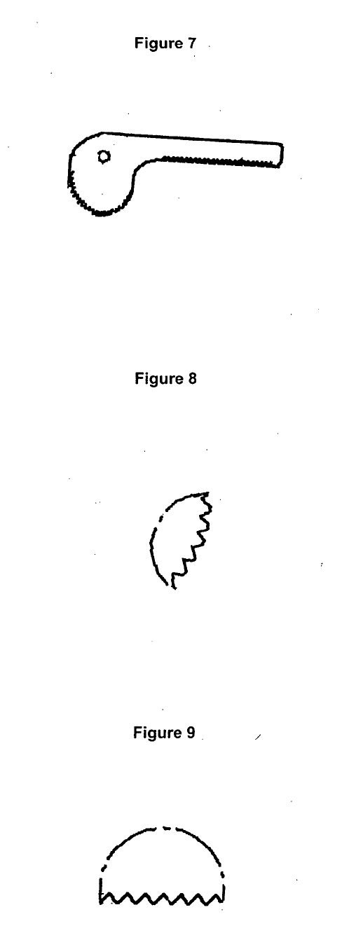

FIGS. 1, 2 and 10 illustrate the locking device. FIGS. 3 to 5 illustrate the main body element. FIGS. 6 to 9 illustrate the lever locking element. FIGS. 11 and 12 illustrate the conductive clip.

FIGS. 1, 3 and 4 illustrate the main body element comprising a groove or tube through which the length of linear flexible material may be inserted. In its inserted position the locking device may engage the length of linear flexible material against the walls of the groove or tube. The circumference of the groove or tube is optionally proportionate to the diameter of the length of linear flexible material.

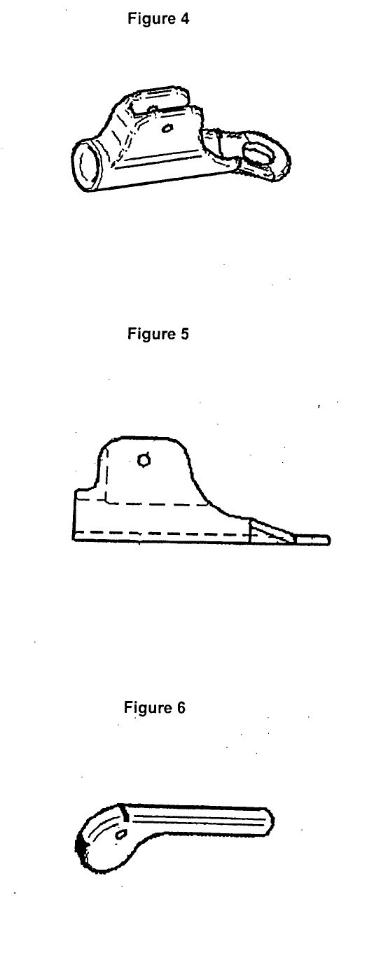

FIGS. 1 and 4 illustrate a circular cavity at an end closer to the lever pivot of the groove or tube formed in the main body element; thereby allowing controlled passage of the length of linear flexible material. Optionally one end of the same length of linear flexible material may be permanently attached to the main body element by passing the length of linear flexible material through the circular cavity in the main body element and securing the length of linear flexible material to itself. Other forms of securing this end of the length of linear flexible material to the main body element may be utilized according to those skilled in the art.

FIG. 2 illustrates the locking device including the main body element and the lever locking element.

The lever locking element is illustrated in FIGS. 6 to 9 from different perspective views and detail. The lever locking element comprises an elongated portion to form a handle and a rounded portion to form a locking means.

As illustrated further detail in FIG. 9, the locking means is optionally in the form of a cam or curved wedge which improves the ability of the locking means to engage the length of linear flexible material holding the length of linear flexible material in place. Moreover, the cam or curved wedge optionally is dentiled or knurled to provide improved grip of the length of linear flexible material.

As illustrated in FIGS. 1, 2 and 10, the lever locking element is attached to the main body element at a pivot point which allows the handle of the lever locking element to be raised away from the main body element which operates to release the locking means. Lowering the handle of the lever locking element toward the main body element operates to engage the locking means.

The handle may have a smooth surface or a textured surface. The textured surface optionally is dentiled or knurled to provide improved grip. Such textured surface is illustrated in further detail in FIG. 8.

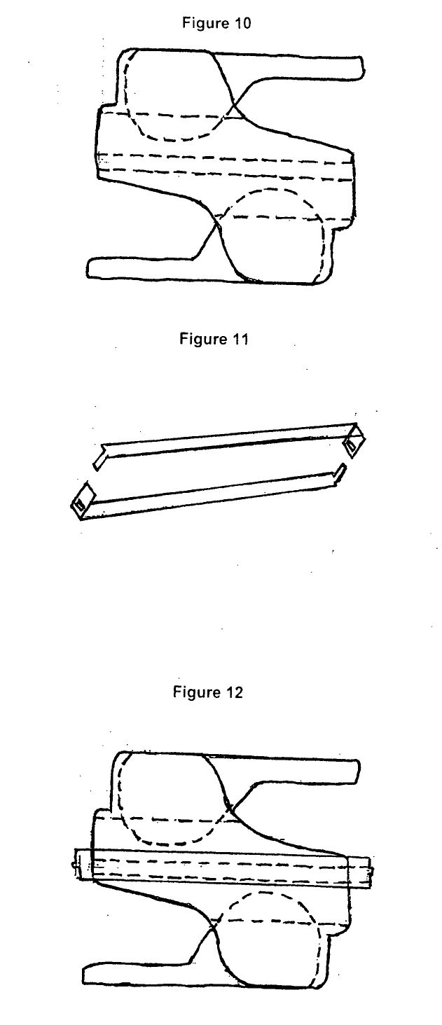

An embodiment of the present invention includes one or more lever locking elements positioned on opposite surfaces of the main body element with each locking means rotating toward central grooves or tubes on opposite surfaces of the main body element as illustrated in FIG. 10.

An embodiment of the present invention includes a conductive clip which encircles the locking device such that an electric current may be conducted through the length of linear flexible material and between multiple conductive flexible materials or wires as illustrated in FIGS. 11 and 12.

An embodiment of the invention includes a fastening means attached to the main body element whereby the lever locking element may be fixed in a position wherein it has engaged the length of linear flexible material. Such fastening means may include a rotatable hook or ring rotationally fixed to the main body element such that it may be rotated to engage and restrict the movement of the handle of the lever locking element.

While the particular preferred embodiment of the present invention has been described, it would be obvious to those skilled in the art that modifications may be made without departing from the teaching of the present invention.

### Example 1

A locking device comprising a main body element injection molded from a durable plastic material further comprising a groove or tube though which a length of braided rope may pass, a lever locking element injection molded from a durable plastic material further comprising a handle and a locking means, which lever locking element is pivotally attached to the main body element such that the lever locking element may engage the braided rope passing through the groove or tube, and such that engagement of the locking means creates a region of the braided rope on either side of the engagement of the locking means of either higher or lower tension for the rope and wherein an opposite end of the rope is permanently secured to the main body element.

### Example 2

A locking device comprising a main body element injection molded from a durable plastic material further comprising a groove or tube though which a length of braided rope may pass, a lever locking element injection molded from a durable plastic material further comprising a handle and a locking means, which lever locking element is pivotally attached to the main body element such that the lever locking element may engage the braided rope passing through the groove or tube, and such that engagement of the locking means creates a region of the braided rope on either side of the engagement of the locking means of either higher or lower tension for the rope and wherein an opposite end of the rope is not permanently secured to the main body element.

### Example 3

A locking device comprising a main body element injection molded from a durable plastic material further comprising a groove or tube though which a braided rope may pass, two lever locking elements injection molded from a durable plastic material, each further comprising a handle and a locking means, which lever locking elements are pivotally attached to the main body element in series such that the two lever locking elements may engage the braided rope twice while passing through the groove or tube, and such that multiple engagement of the locking means permits the imposition of higher tension on the braided rope.

### Example 4

A locking device comprising a main body element injection molded from a durble plastic material further comprising two grooves or tubes on the same surface of the main body element though which two braided ropes may pass, two lever locking elements injection molded from a durable plastic material, each further comprising a handle and a locking means, which lever locking elements are pivotally attached to the main body element and in association with a groove or tube on the same surface of the main body element such that the two braided ropes may pass the grooves or tubes on the same surface of the main body element and be engaged by the lever locking elements in the same direction.

### Example 5

A locking device comprising a main body element injection molded from a durable plastic material further comprising two grooves or tubes on the same surface of the main body element though which two braided ropes may pass, two lever locking elements injection molded from a durable plastic material, each further comprising a handle and a locking means, which lever locking elements are pivotally attached to the main body element and in association with a groove or tube on the same surface of the main body element such that the two braided ropes may pass the grooves or tubes on the same surfaces of the main body element and be engaged by the lever locking elements in opposite directions.

### Example 6

A locking device comprising a main body element injection molded from a durable plastic material further comprising two grooves or tubes on opposite surfaces of the main body element though which two braided ropes may pass, two lever locking elements injection molded from a durable plastic material, each further comprising a handle and a locking means, which lever locking elements are pivotally attached to the main body element and in association with a groove or tube on opposite surfaces of the main body element such that the two braided ropes may pass through the grooves or tubes on opposite surfaces of the main body element and be engaged by the lever locking element in the same direction.

### Example 7

A locking device comprising a main body element injection molded from a durable plastic material further comprising two grooves or tubes on opposite surfaces of the main body element though which two braided ropes may pass, two lever locking elements injection molded from a durable plastic material, each further comprising a handle and a locking means, which lever locking elements are pivotally attached to the main body element and in association with a groove or tube on opposite surfaces of the main body element such that the two braided ropes may pass through the grooves or tubes on opposite surfaces of the main body element and be engaged by the lever locking element in opposite directions.

### Example 8

A locking device comprising a main body element injection molded from a durable plastic material further comprising a conductive material on the inner surface of two grooves or tubes on the same surface of the main body element though which two wires may pass, and which conductive material is conductively connected such that a charge may pass between the conductive material in each groove or tube, two lever locking elements injection molded from a durable plastic material, each further comprising a handle and a locking means, which lever locking elements are pivotally attached to the main body element and in association with a groove or tube on the same surface of the main body element such that the two wires may pass through the grooves or tubes on the same surface of the main body element and be engaged by the lever locking element in opposite directions.

### Example 9

A locking device comprising a main body element injection molded from a durable plastic material further comprising two grooves or tubes on opposite surfaces of the main body element though which two wires may pass, two lever locking elements injection molded from a durable plastic material, each further comprising a handle and a locking means, which lever locking elements are pivotally attached to the main body element in parallel such that the two wires may pass through the two grooves or tubes and be engaged by the lever locking elements in opposite directions, and a conductive clip proportionate to the locking device comprising two mirror image linear components, wherein each linear component comprises an extension on either end of the linear component, which extensions extend at 90 degrees from the linear component, and the extensions further comprise an opening to receive an opposite end of the linear component of a complimentary conductive clip such that the two linear components interlock, and the linear components further comprise a conductive material such that when the two linear components are interlocked encircling the locking device, a charge may pass between the conductive material in each conductive clip and an electric current may be conducted through the wires and between the wires.

I claim:

1. A locking device comprising a main body element further comprising one or more grooves or tubes though which one or more lengths of linear flexible material may pass, one or more lever locking elements each further comprising a handle and a locking means, which lever locking element is pivotally attached to the main body element such that the lever locking element may engage a length of a linear flexible material passing through the one or more grooves or tubes, and such that engagement of the locking means creates a region of the linear flexible material on either side of the engagement of the locking means of either higher or lower tension, wherein the locking device is not permanently attached to a surface.

2. The locking device of claim 1, wherein the one or more grooves or tubes traverses the main body element and such that the one or more lengths of linear flexible material exit the main body element in both high and low tension, depending on the respective end of the main body element in relation to the lever locking element.

3. The locking device of claim 1, wherein the one or more grooves or tubes are proportionate to the diameter of the one or more lengths of linear flexible material.

4. The locking device of claim 1, wherein the main body element further comprises a means for permanently attaching the length of linear flexible material at either one or both the high tension end or low tension end of the main body element.

5. The locking device of claim 1, wherein one end of a single length of linear flexible material may be permanently attached to the main body element and the other end of the single length of linear flexible material may be inserted into the groove or tube of the main body element such that it may be engaged by the locking means.

6. The locking device of claim 1, wherein the lever locking element is positioned such that the locking means is positioned at the high tension end of the main body element and the handle rotatable toward the low tension end of the main body element.

7. The locking device of claim 1, wherein the lever locking element is pivotally attached at the high tension end of the main body element.

8. The locking device of claim 1, wherein the locking means is in the form of a cam or curved wedge which may engage the length of linear flexible material directly against an interior wall of the groove or tube of the main body element when the length of linear flexible material is inserted into the locking device such that tension applied to the high tension end of the length of linear flexible material operates to reinforce the engagement of the cam or curved wedge.

9. The locking device of claim 1, wherein the locking means engages the length of linear flexible material when the handle is rotated toward the main body element, thereby engaging the length of linear flexible material with the cam or curved wedge, and releases the length of linear flexible material when the handle is rotated away from the main body element, thereby disengaging the cam or curved wedge.

10. The locking device of claim 1, wherein the handle surface is smooth or textured.

11. The locking device of claim 1, wherein more than one lever locking elements is pivotally attached to the main body element in series on the same surface of the main body element such that the length of linear flexible material may be engaged by more than one locking means while positioned in the groove or tube of the main body element.

12. The locking device of claim 1, wherein more than one lever locking element is pivotally attached to the main body element in parallel on the same surface of the main body element such that more than one length of linear flexible material may pass through the more than one groove or tube on the same surface of the main body element, and such that more than one locking means may engage the lengths of linear flexible material in the same direction.

13. The locking device of claim 1, wherein more than one lever locking element is pivotally attached to the main body element in bidirectional parallel on the same surface of the main body element such that more than one length of linear flexible material may pass through more than one groove or tube on the same surface of the main body element, and such that more than one locking means may engage the lengths of linear flexible material in opposite directions.

14. The locking device of claim 1, wherein more than one lever locking element is pivotally attached on opposite surfaces of the main body element such that more than one length of linear flexible material may pass through more than one groove or tube on the opposite surfaces of the main body element, and such that more than one locking means may engage the lengths of linear flexible materials in the same direction.

15. The locking device of claim 1, wherein more than one lever locking element is pivotally attached on opposite surfaces of the main body element such that more than one length of linear flexible material may pass through more than one groove or tube on the opposite surfaces of the main body element, and such that more than one locking means may engage the lengths of linear flexible material in opposite direction.

16. The locking device of claim 1, wherein the length of linear flexible material is a rope.

17. The locking device of claim 1, wherein the groove(s) or tube(s) comprise a conductive material on the inner surface of such groove(s) or tube(s) and connecting such groove(s) or tube(s) such that when the locking means is engaged an electric current may be conducted through and between the respective lengths of linear flexible material which are engaged against the groove(s) or tube(s).

18. The locking device of claim 17, wherein the length of linear flexible material is a conductive material such as a wire.

19. The locking device of claim 1, further comprising a conductive clip proportionate to the locking device comprising two mirror image linear components, wherein each linear component comprises an extension on either end of the linear component, which extensions extend at 90 degrees from the linear component, and the extensions further comprise an opening to receive an opposite end of the linear component of a complimentary conductive clip such that the two linear components interlock, and the linear components further comprise a conductive material such that when the two linear components are interlocked encircling the locking device, a charge may pass between the conductive material in each conductive clip and an electric current may be conducted through the wires and between the wires.
